(19) United States
(12) Patent Application Publication
(10) Pub. No.: US 2016/0085682 A1
(43) Pub. Date: Mar. 24, 2016

(54) Caching Methodology for Dynamic Semantic Tables

(71) Applicant: International Business Machines Corporation, Armonk, NY (US)

(72) Inventors: Sandra K. Johnson, Cary, NC (US); Grant D. Miller, Arvada, CO (US)

(21) Appl. No.: 14/521,039

(22) Filed: Oct. 22, 2014

Related U.S. Application Data
(63) Continuation of application No. 14/495,403, filed on Sep. 24, 2014.

(51) Int. Cl. G06F 12/08; G06F 17/30

(52) U.S. Cl. CPC G06F 12/0871; G06F 17/30902

(57) ABSTRACT

A method for caching includes determining a degree of relatedness for a database entry stored in a concept table. The concept table is stored in cache. The degree of relatedness is based on a comparison between a concept of data of the database entry and a concept of the concept table. The method includes determining an amount of data usage for the database entry where the data usage includes an amount of usage of the database entry while in cache. The method includes determining a cache flushing rating for the database entry. The cache flushing rating is determined from the degree of relatedness of the database entry and the amount of data usage of the database entry. The method includes flushing the database entry from the cache in response to the cache flushing rating of the database entry being below a cache flush threshold.

### FIELD

The subject matter disclosed herein relates to caching policies and more particularly relates to a caching policy based on a degree of relatedness.

### BACKGROUND

Database architecture and management is a fairly well known field, but if a database gets sufficiently large, searching the database can be slow. Indexing and caching may help, but if the database is large enough, performance may still be a concern. An association database can grow so large that performance becomes an issue. In addition, typical database tables are designed using fixed taxonomies and information architectural structures that often do not allow fluid creation and relationship management. The tables and fields are typically organized based on adhering to a defined taxonomy.

### BRIEF SUMMARY

A method for caching is disclosed. An apparatus and computer program product also perform the functions of the method. The method, in one embodiment, includes determining a degree of relatedness for a database entry stored in a concept table. The concept table is stored in cache. The degree of relatedness is based on a comparison between a concept of data of the database entry and a concept of the concept table. The method, in some embodiments, includes determining an amount of data usage for the database entry where the data usage includes an amount of usage of the database entry while in cache. The method, in some embodiments, includes determining a cache flushing rating for the database entry. The cache flushing rating is determined from the degree of relatedness of the database entry and the amount of data usage of the database entry. The method includes flushing the database entry from the cache in response to the cache flushing rating of the database entry being below a cache flush threshold.

In one embodiment, the method includes determining a concept related to data for a new database entry in the database, determining a degree of relatedness between the concept of the data of the new database entry and the concept of a concept table stored in cache, and storing the new database entry in the concept table in response to determining that the degree of relatedness is above a relatedness threshold. In a further embodiment, the method includes using latent semantic analysis with respect to the concept of the data of the database entry and the concept of the concept table, where the latent semantic analysis at least results in determining the degree of relatedness between the concept of the data of the database entry and the concept of the concept table. In a further embodiment, the latent semantic analysis includes using singular value decomposition (“SVD”). In yet another further embodiment, the latent semantic analysis includes using term frequency-inverse document frequency and a resulting matrix is processed using singular value decomposition.

In one embodiment, the degree of relatedness is stored in the concept table with the database entry and the concept of the data of the database entry includes a first topic that relates to the database entry and the concept of the concept table includes a second topic that relates to entries in the concept table in cache. In another embodiment, the cache includes two or more concept tables and each concept table is related to a different concept and the method includes creating a new table in cache in response to the degree of relatedness between the concept of the data of the new database entry and the concept of each concept table being below the relatedness threshold, where the created concept table includes the concept of the data of the new database entry.

In one embodiment, the cache flush threshold is dynamic and changes based on one or more of cache resources and cache requirements of data written to cache. In another embodiment, the data usage is determined from frequency of use of data of the database entry, cache accesses to the database entry, cache hits of the database entry, and/or cache misses. In another embodiment, the method includes flushing several of entries from the cache where each flushed database entry has a cache flushing rating below the cache flush threshold. In another embodiment, the method includes flushing concept tables and associated entries in the concept tables from cache in response to reconfiguring the database. In a related embodiment, reconfiguring the database is triggered by a number of requests to the database reaching a request limit, a percentage of data change within the database reaching a change limit, an operation time of the database reaching an operation time limit, and/or an amount of new data added to the database reaching a new data limit.

In another embodiment, the method also includes, in response to flushing the concept tables and entries in the concept tables from cache, processing entries in the database to extract one or more concepts. The one or more concepts are stored in one or more concept tables in cache along with data and associated entries from the database that relate to the one or more concepts. Each database entry stored in a concept table has a degree of relatedness above a relatedness threshold and the degree of relatedness stored with the database entry in the concept table. In another embodiment, the cache includes two or more cache levels and each cache level includes a cache flush threshold, where flushing the database entry from the cache in response to the cache flushing rating of the database entry being below a cache flush threshold includes flushing the database entry from a cache level in response to the cache flushing rating of the database entry being below a cache flush threshold for the cache level.

An apparatus for caching includes a DOR read module, in one embodiment, that determines a degree of relatedness for a database entry stored in a concept table. The concept table is stored in cache and the degree of relatedness is based on a comparison between a concept of data of the database entry and a concept of the concept table. The apparatus, in one embodiment, includes a data usage module that determines an amount of data usage for the database entry where the data usage includes an amount of usage of the database entry while in cache, and a flushing rating module that determines a cache flushing rating for the database entry. The cache flushing rating is determined from the degree of relatedness of the database entry and the amount of data usage of the database entry. The apparatus, in one embodiment, includes a flushing module that flushes the database entry from the cache in response to the cache flushing rating of the database entry being below a cache flush threshold.

In one embodiment, the apparatus includes a concept module that determines a concept related to data for a new database entry in the database, a DOR module that determines a degree of relatedness between the concept of the data of the new database entry and the concept of a concept table stored in cache, and a storing module that stores the new database entry in the concept table in response to determining that the degree of relatedness is above a relatedness threshold. In another embodiment, the apparatus includes using latent semantic analysis with respect to the concept of the data of the database entry and the concept of the concept table, where the latent semantic analysis at least results in determining the degree of relatedness between the concept of the data of the database entry and the concept of the concept table. In another embodiment, the cache includes two or more concept tables and each concept table is related to a different concept, and the apparatus includes a concept table module that creates a new table in cache in response to the degree of relatedness between the concept of the data of the new database entry and the concept of each concept table being below the relatedness threshold. The concept table created by the concept table module includes the concept of the data of the new database entry.

In one embodiment, the flushing module further flushes several of entries from the cache, where each flushed database entry has a cache flushing rating below the cache flush threshold. In another embodiment, the apparatus includes a cache reconfiguration module that flushes the concept tables and entries associated with the concept tables from cache in response to reconfiguring the database. In another embodiment, the apparatus also includes a regeneration module that, in response to the cache reconfiguration module flushing the concept tables and entries in the concept tables from cache, processes entries in the database to extract one or more concepts. In one embodiment, the one or more concepts are stored in one or more concept tables in cache along with data and associated entries from the database that relate to the one or more concepts and each database entry stored in a concept table has a degree of relatedness above a relatedness threshold. The degree of relatedness may be stored with the database entry in the concept table. In another embodiment, the apparatus includes a computer, where the computer includes the cache and one or more processors in communication with the cache.

A computer program product for caching is included. The computer program product includes a computer readable storage medium having program instructions embodied therewith. The program instructions are readable/executable by a processor to cause the processor to determine a degree of relatedness for a database entry stored in a concept table, determine an amount of data usage for the database entry, the data usage comprising an amount of usage of the database entry while in cache, determine a cache flushing rating for the database entry, and flush the database entry from the cache in response to the cache flushing rating of the database entry being below a cache flush threshold. The concept table is stored in cache, and in one embodiment, along with the degree of relatedness. The database entry is from a database and the degree of relatedness is based on a comparison between a concept of data of the database entry and a concept of the concept table. The cache flushing rating is determined from the degree of relatedness of the database entry and the amount of data usage of the database entry.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings:

FIG. 1 is a schematic block diagram illustrating one embodiment of a system with a caching apparatus in accordance with one embodiment of the present invention.

FIG. 2 is a schematic block diagram illustrating a data processing system depicted in accordance with one embodiment of the present invention.

FIG. 3 is a schematic block diagram illustrating one embodiment of an apparatus for flushing cache in accordance with one embodiment of the present invention.

FIG. 4 is a schematic block diagram illustrating another embodiment of an apparatus for flushing cache in accordance with one embodiment of the present invention.

FIG. 5 is a diagram of one embodiment of cache with concept tables in accordance with one embodiment of the present invention.

FIG. 6 is a schematic flow chart diagram illustrating one embodiment of a method for flushing cache in accordance with one embodiment of the present invention.

FIG. 7 is a schematic flow chart diagram illustrating one embodiment of a method for organizing cache in accordance with one embodiment of the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

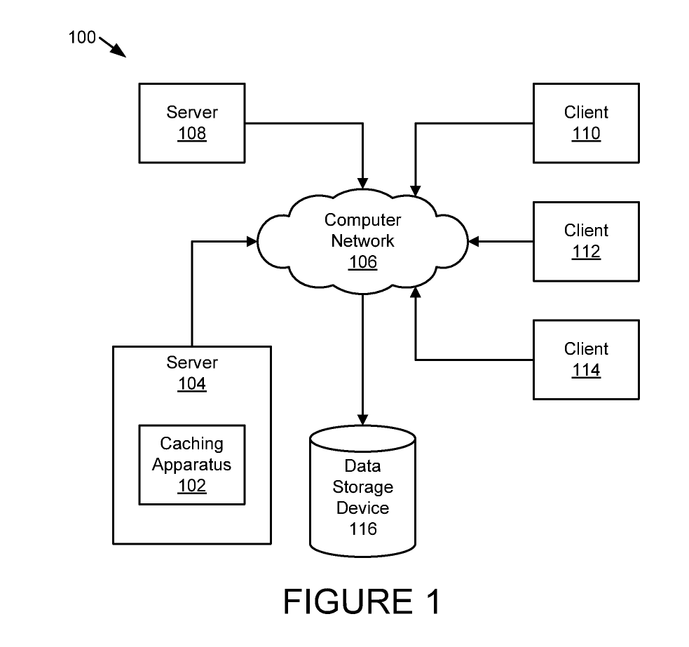

FIG. 1 is a schematic block diagram illustrating one embodiment of a system 100 with a caching apparatus in accordance with one embodiment of the present invention. The system 100, in one embodiment, includes a caching apparatus 102 in a server 104, a computer network 106 connecting another server 108 and clients 110, 112, 114 and a data storage device 116, which are described below.

The system 100, in one embodiment, is a network data processing system and is a network of computers in which the illustrative embodiments may be implemented. The system 100 includes a server 104 with a caching apparatus 102. The server 104 typically includes one or more processors and may include a mainframe computer, a workstation, a desktop computer, a computer system in a computer rack, and the like. In general, the caching apparatus 102 stores data related to a database in cache based on a degree of relatedness (“DOR”) between concepts associated with the database entry. For example, a concept may be “doctor” and data entries with the term “doctor” may be included as well as data entries with other related concepts or terms, such as “physician,” “MD,” “clinician,” etc. While “physician” may have a high degree of relatedness to “doctor,” other terms may also be related to a lesser degree, such as “nurse.” While single words are mentioned in this example, a concept may also be a broader topic and a database entry may have lines, paragraphs, etc. that discuss the topic and may be related based on discussion in the text rather than specific words. For example, text discussing doctors in depth may have a higher degree of relatedness to “doctor” than text that merely mentions “doctor.”

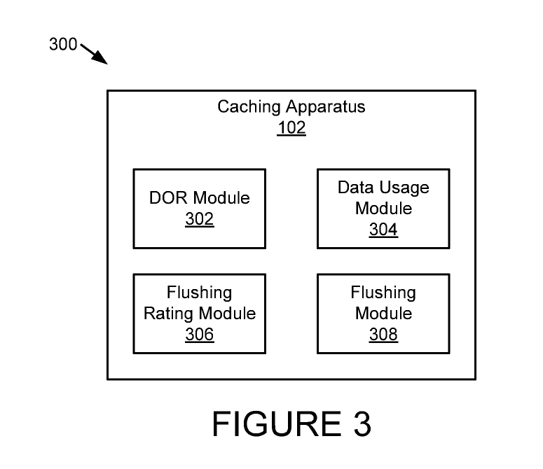

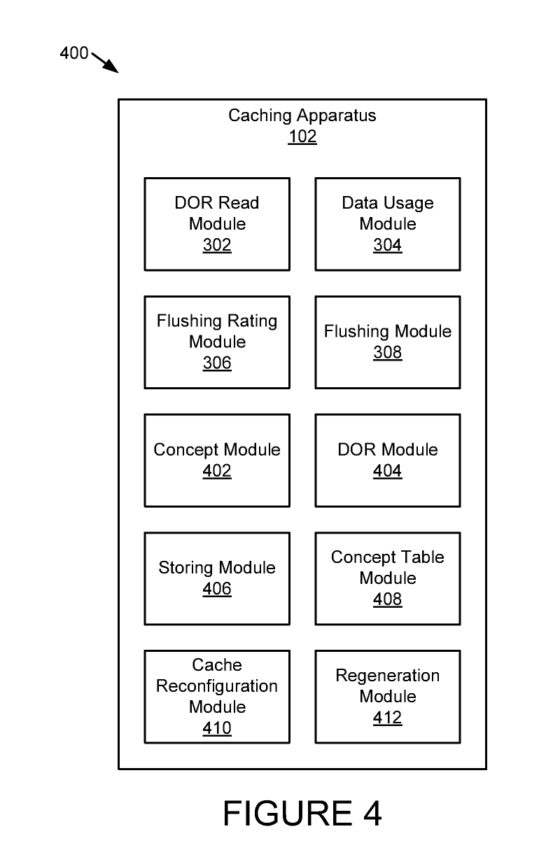

The cache, in one embodiment, is organized to include concept tables where each concept table includes one or more concepts and data for entries in the database related to each concept. In another embodiment, a concept table may include multiple concepts where each concept has one or more entries. A degree of relatedness may also be stored with each database entry. Cache is a limited resource so data must be flushed when the cache is full and new data is added. The caching apparatus 102 flushes entries from the concept tables stored in cache based on a combination of a degree of relatedness and data usage of the entries. Where the combined degree of relatedness and data usage for a database entry is below a cache flush threshold, the database entry may be flushed. In one embodiment, the cache flush threshold is dynamic and changes based on factors such as cache size, amount of data to be cached, etc. The caching apparatus 102 is discussed in more detail with regards to the apparatuses 300, 400 of FIGS. 3 and 4.

The system includes a computer network 106, which is one medium used to provide communications links between various devices and computers connected together within the system 100. The computer network 106 may include connections, such as wire, wireless communication links, fiber optic cables, etc. and may also include other equipment, such as routers, switches, computers, and the like.

In the depicted example, the servers 104, 108 connect to the computer network 106 along with a data storage device 116. The servers 104 may access the data storage device 116 and may store data on the data storage device 116, such as a database. In one embodiment, the data storage device includes multiple storage devices, and may be part of a storage area network (“SAN”), or other storage system. In addition, client computers 110, 112, and 114 may connect to the computer network 106. The client computers 110, 112, and 114 may be, for example, personal computers, network computers, laptop computers, workstations, and the like and may access resources on the servers 104, 108. In the depicted example, the server 104 may provide information, such as boot files, operating system images, and applications to the client computers 110, 112, and 114. The client computers 110, 112, and 114 are clients to the server 104 in this example. The system 100 may include additional server computers, client computers, and other devices not shown.

Program code located in the system 100 may be stored on a computer recordable storage medium and downloaded to a data processing system or other device for use. For example, program code may be stored on a computer recordable storage medium on the server 104 and downloaded to client computer 110 over the computer network 106 for use on client computer 110 or may be accessed by a client computer 110 while executing on the server 104.

In the depicted example, the system 100 may include the Internet and at least a portion of the computer network 106 may represent a worldwide collection of networks and gateways that may use the Transmission Control Protocol/Internet Protocol (TCP/IP) suite of protocols or other protocols to communicate with one another. The Internet may include a backbone of high-speed data communication lines between major nodes or host computers that may include thousands of commercial, governmental, educational and other computer systems that route data and messages. Of course, the system 100 also may be implemented as a number of different types of networks, such as, for example, an intranet, a local area network (“LAN”), a wide area network (“WAN”), a wireless network, etc. and may include a combination of network types. FIG. 1 is intended as an example, and not as an architectural limitation for the different illustrative embodiments.

Computers in the system 100, such as the client computers 110, 112, 114 and the servers 104, 108, implement illustrative embodiments to manage information. In these examples, a client computer, such as client computer 110, connects to a server computer, such as the server 104 with the caching apparatus 102. The client computer 110 may then request that information be stored in a database accessible to the server 104. The server 104 may run a database management system, which may include or coordinate with the caching apparatus 102. A database management system, in one embodiment, includes software that stores data in a database and that retrieves data from the database in response to a query for data matching particular criteria.

The server 104, in one embodiment, receives the request containing the information from a client computer 110 and the caching apparatus 106 may perform a latent semantic analysis on each of the collections of textual information in the database and the information in the request. In some illustrative embodiments, results of previous latent semantic analyses performed on the collections of textual information are stored in cache on the server 104. In such illustrative embodiments, the results of the previous latent semantic analyses may be used in performing the latent semantic analysis on the information in the request. In these examples, each collection of textual information is stored as a concept table in cache. Each concept table in cache is also associated with at least one concept and is stored in cache. A concept is a topic for a concept table that describes the contents of the concept table.

Latent semantic analysis (“LSA”), in one embodiment, is a process that identifies patterns in the relationships between the terms contained in a collection of text. Latent semantic analysis typically uses the principle that words that are used in the same contexts in the text tend to have similar meanings. Latent semantic analysis can generate one or more concepts from a collection of text. The one or more concepts are terms in the collection of text that are determined by the latent semantic analysis to represent the topic of the collection of text.

Thus, the caching apparatus 102 in the server 104 performs a latent semantic analysis on the information and the concept for each of the concept tables in cache to generate a degree of relatedness between the information from the request and each of the concept tables in cache. A request may be a request to store new content in a database entry in the database, a request to compare against content in entries stored in the database, etc. The degree of relatedness, in one embodiment, is a numeric value that represents how closely information in the request is related to a particular concept. For example, “orange” has a higher degree of relatedness to “color” than “door.”

Once the degree of relatedness is generated between the information of a new database entry in the request and the concept for each of the concept tables in cache, in one embodiment, the caching apparatus 102 in the server 104 attempts to identify a concept table that has a concept that is within a specified degree of relatedness with the concept for the information in the request. For example the degree of relatedness between the information of the new database entry and a concept of a concept table may be above a relatedness threshold. In one embodiment, the caching apparatus 102 stores the concept table in cache. If a concept table is identified and the degree of relatedness between the information of the new database entry and the concept of the concept table is above the relatedness threshold, the caching apparatus 102 then associates the information in the request with the concept table having the concept with the highest degree of relatedness to the information in the request or in each concept table where the degree of relatedness is above the relatedness threshold. The new concept may be stored in the database at the time the new entry is stored in cache or the new entry may be stored in the database at a later time.

In some embodiments, the caching apparatus 102 associates the information with the concept table by adding a row to the concept table containing the information. In another embodiment, the caching apparatus 102 associates the information with the concept table by placing in the concept table a link to a location of the database entry in the database. In one embodiment, if no concept table is identified as having a concept that is related to the information in the request within the specified degree of relatedness, a new concept table is created in cache to contain the information. In some illustrative embodiments, the caching apparatus 102 then associates one or more concepts for the information with the concept table.

In some embodiments, the concept tables are stored in cache in a hierarchy. In illustrative embodiments in which the concept tables are stored in a hierarchy, the caching apparatus 102 compares the degree of relatedness between the information in the request and the concept for each of the concept tables at a first level of the hierarchy and identifies the concept table having a concept with a degree of relatedness that exceeds a specified degree of relatedness at the particular level of the hierarchy.

The caching apparatus 102 may then perform a latent semantic analysis on the information in the request and the concept for each of the concept tables at the second level of the hierarchy that are directly subordinate to the concept table at the first level of the hierarchy. The caching apparatus 102 may then identify the concept table at the second level of the hierarchy that has a degree of relatedness that exceeds a specified degree of relatedness between the information and the concept for the concept table, as well as a higher degree of relatedness between the information and the concept for the concept table at the second level of the hierarchy than the degree of relatedness between the information and the concept for the superior concept table at the first level of the hierarchy.

Cache is not unlimited so when cache is full, additional data may not be stored in cache without overwriting data or removing data and then storing new data in a location of the removed data. The caching apparatus 102 determines a degree of relatedness for a database entry stored in a concept table and an amount of data usage of the database entry and then uses the degree of relatedness and the data usage to determine a cache flushing rating for the database entry. The caching apparatus 102 flushes a database entry where the cache flushing rating is below a cache flush threshold. The cache flush threshold, in one embodiment is dynamic and may vary based on amount of data being written to the cache, cache resources, etc. Cache flushing will be described in more detail with regard to the apparatuses 300, 400 of FIGS. 3 and 4.

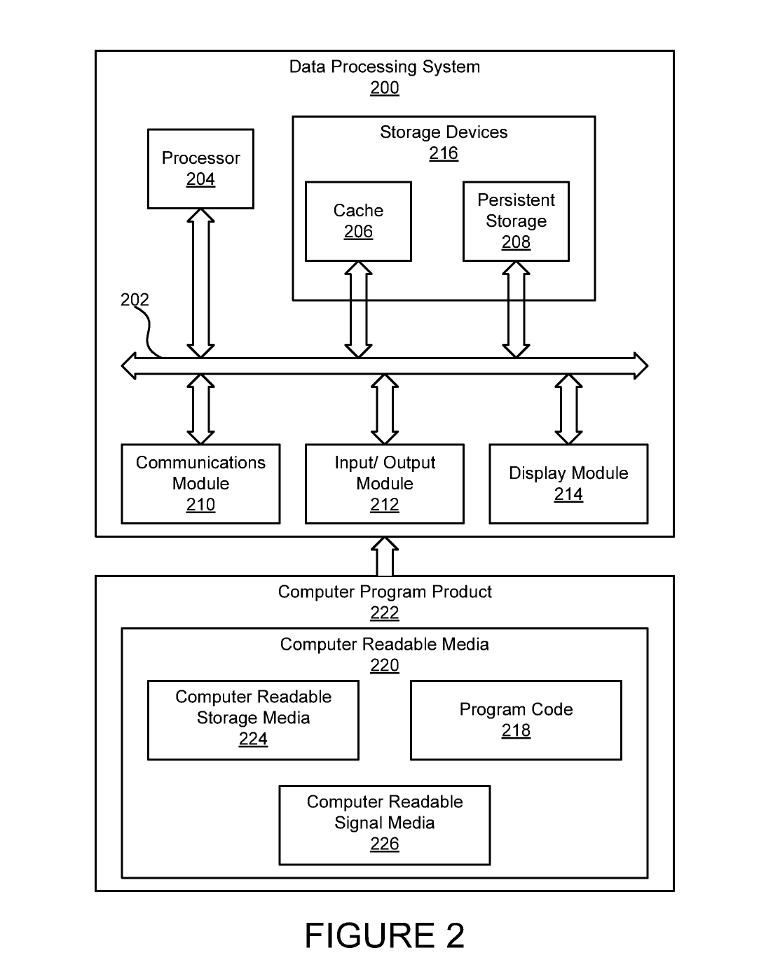

FIG. 2 is a schematic block diagram illustrating a data processing system 200 depicted in accordance with one embodiment of the present invention. The data processing system 200 may include a communications fabric 202, which provides communications between a processor unit 204, a cache 206, a persistent storage 208, a communications unit 210, an input/output (I/O) unit 212, a display 214, and other devices. The data processing system 200 is an example of a data processing system that can be used to implement server computers 104, 108 and client computers 110, 112, 114 in the system 100 of FIG. 1.

The processor unit 204, in one embodiment, serves to execute instructions for software that may be loaded into cache 206. The processor unit 204 may include a number of processors, may be a multi-processor core, or some other type of processor, depending on the particular implementation. A “number”, as used herein, with reference to an item, means “one or more items”. Further, processor unit 204 may be implemented using a number of heterogeneous processor systems in which a main processor is present with secondary processors on a single chip. As another illustrative example, the processor unit 204 may be a symmetric multi-processor system containing multiple processors of the same type.

The cache 206 and the persistent storage 208 are examples of storage devices 216. The cache 206, in one embodiment, is a component that stores data so that future requests for the data can be served faster than when the data is stored in persistent storage 208 or other locations. For example, cache 206 may be physically located closer to a processor 204 and may be faster than other memory devices in a computer. Typically data stored in cache 206 is a copy of data stored elsewhere, such as in a database. In other embodiments, data is first stored in cache 206 and is later stored in persistent storage 208. Typically, cache 206 is a type of memory and may be volatile memory where contents are lost when power is lost.

A storage device is any piece of hardware that is capable of storing information, such as, for example without limitation, data, program code in functional form, and/or other suitable information either on a temporary basis and/or a permanent basis. The cache 206, in these examples, may be, for example, a random access memory or any other suitable volatile or non-volatile storage device. The persistent storage 208 may take various forms depending on the particular implementation. For example, the persistent storage 208 may contain one or more components or devices. For example, the persistent storage 208 may include a hard drive, a flash memory, a rewritable optical disk, a rewritable magnetic tape, a storage area network, or some combination of the above. The media used by the persistent storage 208 also may be removable. For example, a removable hard drive may be used for the persistent storage 208.

The communications unit 210, in these examples, provides for communications with other data processing systems or devices. In these examples, the communications unit 210 may include a network interface card. The communications unit 210 may provide communications through the use of either or both physical and wireless communications links.

The input/output unit 212, in one embodiment, allows for input and output of data with other devices that may be connected to the data processing system 200. For example, the input/output unit 212 may provide a connection for user input through a keyboard, a mouse, and/or some other suitable input device. Further, the input/output unit 212 may send output to a printer or other device. The display 214, in one embodiment, provides a mechanism to display information to a user.

Instructions for the operating system, applications and/or programs may be located in the storage devices 216, which are in communication with the processor unit 204 through the communications fabric 202. In these illustrative examples, the instructions are in a functional form on the persistent storage 208. These instructions may be loaded into cache 206 for execution by the processor unit 204. The processes of the different embodiments may be performed by the processor unit 204 using computer implemented instructions, which may be located in a memory, such as cache 206.

These instructions are referred to as program code, computer usable program code, or computer readable program code that may be read and executed by a processor in the processor unit 204. The program code in the different embodiments may be embodied on different physical or computer readable storage media, such as cache 206 or the persistent storage 208.

Program code 218 is located in a functional form on computer readable media 220 that is selectively removable and may be loaded onto or transferred to the data processing system 200 for execution by the processor unit 204. The program code 218 and the computer readable media 220 form a computer program product 222 in these examples. In one example, the computer readable media 220 may be computer readable storage media 224 or computer readable signal media 226. The computer readable storage media 224 may include, for example, an optical or magnetic disc that is inserted or placed into a drive or other device that is part of the persistent storage 208 for transfer onto a storage device, such as a hard drive that is part of the persistent storage 208. The computer readable storage media 224 also may take the form of a persistent storage 208, such as a hard drive, a thumb drive, or a flash memory that is connected to the data processing system 200 and includes the program code 218. In some instances, the computer readable storage media 224 may not be removable from the data processing system 200. In these illustrative examples, the computer readable storage media 224 is a non-transitory computer readable storage media.

Alternatively, the program code 218 may be transferred to the data processing system 200 using a computer readable signal media 226. The computer readable signal media 226 may be, for example, a propagated data signal containing the program code 218. For example, the computer readable signal media 226 may be an electro-magnetic signal, an optical signal, and/or other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples. The computer readable storage media 224 is distinct from the computer readable signal media 226.

In some illustrative embodiments, the program code 218 may be downloaded over a network to the persistent storage 208 from another device or data processing system through the computer readable signal media 226 for use within the data processing system 200. For instance, the program code 218 stored in a computer readable storage medium 224 in a data processing system may be downloaded over a network, such as the computer network 106 of the system 100 of FIG. 1, from a server 108 to the data processing system 200. The data processing system providing the program code 218 may be a server (e.g. 108), a client computer (e.g. 110, 112, 114), or some other device capable of storing and transmitting the program code 218.

The different components illustrated for the data processing system 200 are not meant to provide architectural limitations to the manner in which different embodiments may be implemented. The different illustrative embodiments may be implemented in a data processing system including components in addition to or in place of those illustrated for the data processing system 200. Other components shown in FIG. 2 can be varied from the illustrative examples shown. The different embodiments may be implemented using any hardware device or system capable of executing program code. As one example, the data processing system may include organic components integrated with inorganic components, and/or may be comprised entirely of organic components, excluding a human being. For example, a storage device may be comprised of an organic semiconductor. As another example, a storage device 216 in the data processing system 200 is any hardware apparatus that may store data. Cache 206, persistent storage 208 and computer readable media 220 are examples of storage devices in a tangible form.

In another example, a bus system may be used to implement the communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit 210 may include one or more devices used to transmit and receive data, such as a modem or a network adapter. Further, a cache 206 may be, for example, multi-level cache 206 or other memory, such as found in an interface and memory controller hub that may be present in the communications fabric 202.

The different illustrative embodiments recognize and take into account a number of different considerations. For example, the different illustrative embodiments recognize and take into account that creating groups of textual information from a data source, such as a database, that are related within a particular degree of relatedness decreases the time used to perform a query for data in the data source. The time used to perform the query is decreased because the query is directed at concept tables containing records that are closely related to the search terms in the query, and therefore, likely to be in the result set for the query are processed. Additionally, concept tables containing records that are not closely related to the search terms in the query are not processed.

The different illustrative embodiments also recognize that creating concept tables in cache 206 for text that is not within a particular degree of relatedness of a concept of another table in the database reduces administration costs for a database because the configuration of the database may be altered without a human to identify a favorable alteration and make the alteration in the database. Other illustrative embodiments also recognize that flushing entries from cache 206 based on a combination of a degree of relatedness and a data usage of the database entry allows entries that are used less and/or have a lower degree of relatedness, and thus will more likely be accessed less when related data is accessed.

Additionally, the caching apparatus 102 may reconfigure the database by reanalyzing data already stored in the database. In other words, the caching apparatus 102 may identify a collection of textual information in the database having a concept that has at least a particular degree of relatedness to text already stored in the database using a latent semantic analysis. The caching apparatus 102 may then remove the existing association for the text and create a new association for the text with the collection of textual information identified as having the particular degree of relatedness. For example, the caching apparatus 102 may flush the concept tables from cache 206. In these examples, the caching apparatus 102 may remove the existing association by flushing the concept tables from cache 206 and create the new association by removing the text from one concept table and inserting the text into another concept table or a new concept table. The reconfiguration of the database for data already stored in the database may be performed in response to a particular occurrence, such as a period of time, a number of database transactions, or an amount of disk space used by the database.

The different illustrative embodiments also recognize and take into account that available system resources may have an effect on the length of time for performing latent semantic analysis on the text and the concepts for the collections of textual information. When a small number of system resources are available, the semantic analysis may take longer than when a large number of system resources are available. For example, system resources may include processor 204 and cache 206 availability. The different illustrative embodiments recognize and take into account that using a degree of relatedness that corresponds to the number of available system resources reduces the amount of time taken to store the data in the database when few system resources are available. In addition, flushing entries from cache 206 based on a combination of degree or relatedness and data usage of the database entry may remove less useful and/or less related entries in favor of storing other entries that may be more relevant and may be used more. However, the degree of relatedness that corresponds to the number of available system resources may be increased when many system resources are available. The text is associated with a collection of textual information that is more related to the text when many system resources are available.

Thus, the different illustrative embodiments provide a method, a computer program product, and an apparatus for managing information. A request to store text in a concept table in cache 206 is received by a processor unit 204. The request typically contains the text, but the text may be included in a separate operation. A concept of data for a new database entry is determined and is compared to a concept of a concept table in cache 206 to determine a degree of relatedness between the concept of the data of the new database entry and the concept of the concept table. Where the degree of relatedness is above a relatedness threshold, the new database entry may be stored in the concept table.

FIG. 3 is a schematic block diagram illustrating one embodiment of an apparatus 300 for flushing cache in accordance with one embodiment of the present invention. The apparatus 300 includes one embodiment of the caching apparatus 102 that includes a DOR read module 302, a data usage module 304, a flushing rating module 306, and a flushing module 308, which are described below.

The apparatus 300, in one embodiment, includes a DOR read module 302 that determines a degree of relatedness (“DOR”) for a database entry stored in a concept table. The concept table, in one embodiment, is stored in cache 206 along with the degree of relatedness. Typically, the database entry is stored in a database and is also stored in the concept table in a previous operation and a degree or relatedness between a concept of data in the database entry and the concept of the concept table is above a relatedness threshold. The database may be in persistent storage 208. For example the DOR read module 302 may read a concept table and may read the degree of relatedness associated with the database entry from the concept table. In another embodiment, the DOR read module 302 recalculates the degree of relatedness between the concept of the database entry and the concept of the concept table. In another embodiment, the DOR read module 302 determines a degree of relatedness for a plurality of entries in one or more concept tables in cache 206. The DOR read module 302 may read all entries in all of the concept tables stored in cache 206.

The apparatus 300, in one embodiment, includes a data usage module 304 that determines an amount of data usage for the database entry. The data usage includes an amount of usage of the database entry while in cache 206. Data usage may be determined based on various data usage metrics known to those of skill in the art. For example, data usage may include evaluating, for the database entry, frequency of use of data of the database entry, cache accesses to the database entry, cache hits of the database entry, cache misses, and the like. Frequency of use, cache hits, and the like, in one embodiment are used to determine data usage in the form of a number, a score, a rating, or other useful expression of data usage of the database entry.

In one embodiment, the apparatus 300 includes a flushing rating module 306 that determines a cache flushing rating for the database entry. The cache flushing rating is determined from the degree of relatedness of the database entry and the amount of data usage of the database entry. For example, where the degree of relatedness and the data usage for the database entry are expressed as numbers, the cache flushing rating may be determined by some combination of the degree or relatedness and data usage. In one case, the flushing rating for the database entry may be determined by multiplying the degree of relatedness by the data usage of the database entry. If the degree of relatedness and data usage are expressed as a number between zero and one, the database entry may have a degree of relatedness of 0.8 and a data usage of 0.5 so the flushing rating may be 0.8×0.5=0.4. In another example, the degree of relatedness and the data usage may be added together. Other methods for determining a flushing rating may include using a lookup table, weighting the degree of relatedness and/or data usage, using a formula, etc.

In one example, the cache flushing rating is stored in the concept table. For example, the flushing rating module 306 may store the cache flushing rating along with the degree of relatedness and the data usage. The flushing rating module 306, in one example, updates the cache flushing rating as the data usage is updated. The flushing rating module 306 may also update the cache flushing rating if the degree of relatedness changes. In another example, the concept table includes a formula and the flushing rating module 306 determines the cache flushing rating by applying the formula to the degree of relatedness and/or the data usage of the database entry. In another embodiment, the flushing rating module 306 determines the cache flushing rating in preparation to the flushing module 308 comparing the cache flushing rating with a cache flush threshold, as described below.

The apparatus 300, in one embodiment, includes a flushing module 308 that flushes the database entry from the cache 206 in response to the cache flushing rating of the database entry being below a cache flush threshold. For example, if the flushing rating of the database entry is 0.4 and the cache flush threshold is 0.42, the flushing module 308 may flush the database entry from the concept table containing the database entry, where the concept table is in cache 206. Typically, with regard to a particular value of a flushing rating and a cache flush threshold, the degree of relatedness and the data usage will have an inverse relationship. For example, an database entry with a high degree of relatedness and a low data usage may have a flushing rating above the cache flush threshold while an database entry with a low degree of relatedness and a high data usage may also have a flushing rating above the cache flush threshold. Some combination of a degree of relatedness and a data usage will result in a flushing rating for a database entry that is below the cache flush threshold.

A degree of relatedness for a particular database entry in a concept table may be constant and the flushing rating for a database entry typically may then vary over time as the data usage for the database entry varies. In one embodiment, the flushing rating module 306 may determine a flushing rating for a database entry and the flushing module 308 may determine if the flushing rating is below the cache flush threshold based on a particular event. For example, the event may be related to a request to store more entries in one or more concept tables in cache 206 when the cache 206 is full or nearly full. In another embodiment the event may be a maintenance event that periodically flushes entries from concept tables in cache 206 with flushing rating below a cache flush threshold.

In some embodiments, the cache flush threshold is dynamic. For example, the cache flush threshold may vary based on cache resources, such as an amount of available cache 206, a need for using cache 206 to store executable code or data, or other event that uses cache resources. The cache flush threshold may also vary based on a particular need, such as storing an amount of data in cache 206 that exceeds an amount of available cache. For example, if a particular amount of cache 206 is available and a request to store data exceeds the available cache by a relatively small amount, the cache flush threshold may be maintained or may decrease and if a request to store data exceeds the available cache by a relatively large amount, the cache flush threshold may increase. In general, where factors dictate that more cache 206 is needed, the cache flush threshold may increase to flush more entries from concept tables and where less cache 206 is needed, the cache flush threshold may decrease. One of skill in the art will recognize other factors to dynamically vary the cache flush threshold.

While the description of the apparatus 300 above is described in terms of a single database entry, one of skill in the art will recognize that the apparatus 300 may be used to evaluate numerous entries in numerous concept tables in cache 206. For example, the apparatus 300 may be used to evaluate each database entry in each concept table in cache 206 to flush entries.

In one embodiment, the cache 206 includes multiple cache levels and each cache level may use a single cache flush threshold or each cache level may have a separate cache flush threshold. For example, a cache level closer to a processor 204 may have a higher cache flush threshold than a cache level further away from the processor 204. In another embodiment, cache flush thresholds for various cache levels are based on a capacity of the cache levels. In some embodiments, the cache flush threshold for each cache level varies independently. In other embodiments, the cache flush threshold for each cache level varies with the other cache flush thresholds. In one embodiment, the flushing module 308 flushes a database entry from a higher level of cache 206 to a lower level of cache when the flushing rating for the database entry is below the cache flush threshold for the higher cache level. The flushing module 308 may flush a database entry from a higher level to a lower level of cache 206 until the database entry is flushed from the lowest level of cache 206. One of skill in the art will recognize other ways to manage cache flushing in a multi-level cache 206.

In one embodiment, the flushing module 308 flushes a database entry from cache 206 by marking the database entry as invalid where new data may be stored over an invalid cache line. In another embodiment, the flushing module 308 writes over a database entry. In another embodiment, the flushing module 308 marks a database entry as invalid and another housekeeping operation moves valid data to another location, for example if cache is flash memory or other non-volatile cache. One of skill in the art will recognize other ways to flush cache.

FIG. 4 is a schematic block diagram illustrating another embodiment of an apparatus 400 for flushing cache in accordance with one embodiment of the present invention. The apparatus 400 includes another embodiment of the caching apparatus 102 with a DOR read module 302, a data usage module 304, a flushing rating module 306, and a flushing module 308, which are substantially similar to those described above in relation to the apparatus 300 of FIG. 3. In various embodiments, the apparatus 400 may also include a concept module 402, a DOR module 404, a storing module 406, a concept table module 408, a cache reconfiguration module 410 and a regeneration module 412, which are described below.

In one embodiment, the apparatus 400 includes a concept module 402 that determines a concept related to data for a new database entry in the database. For example a request to the database may include data to be stored in the database. The data will typically be stored in a database entry in the database. The concept module 402 determines a concept related to the data of the request to be stored as a new database entry in the database. The concept may be a topic of the data, a key word of the data, etc. In another embodiment, the apparatus 400 includes a DOR module 404 that determines a degree of relatedness between the concept of the data of the new database entry and the concept of a concept table stored in cache 206. For example, a concept of a concept table may be “fruit” and the concept module 402 may determine that the concept of the data of a new database entry is “apple.” The DOR module 404 may determine a degree of relatedness between “fruit” and “apple.” “Apple” may have a higher degree of relatedness to “fruit” than the degree of relatedness between “bean” and “fruit.” In one embodiment where the caching apparatus 102 includes a DOR module 404, the DOR module 404 may determine a degree of relatedness, prior to the flushing rating module 306 determining a cache flushing rating, by re-calculating the degree of relatedness between the concept of the concept table and the concept of the data of the database entry.

In one embodiment, the concept module 402 and/or the DOR module 404 uses latent semantic analysis, as described above, to determine a concept of the data of the new database entry and to determine a degree of relatedness between the concept of the data of the new database entry and the concept of a concept table. In one embodiment the latent semantic analysis is performed using singular value decomposition (“SVD”). Singular value decomposition is a factorization of a real or complex matrix. In one embodiment, the singular value decomposition of an m×n matrix M is a factorization of the form M=UΣV*, where U is an m×m unitary matrix, Σ is an m×n rectangular diagonal matrix with non-negative real numbers on the diagonal, and V* (which is the conjugate transpose of V) is an n×n unitary matrix. In one embodiment, the diagonal entries of Σ_{i,i} of Σ are known as singular values of M. The m columns of U and n columns of V are typically called the singular values of M. In one embodiment, the m columns of U and the n columns of V are called the left-singular vectors and right-singular vectors of M, respectively. Singular value decomposition, in one embodiment, reduces the dimensional representation of a matrix generated in a latent semantic analysis process and reduces “noise.” In one embodiment, the single value decomposition of the matrix is performed by making a function call to a library routine for generating SVD values.

In another embodiment, a matrix in a latent semantic analysis process is generated that contains values for the number of times each of the terms appeared in the text of a database entry. In these examples, the values are calculated using term frequency-inverse document frequency. Term frequency-inverse document frequency (“TFIDF”) is a weighting formula defined as the following:

$${TFIDF}_{i , j} = ( \frac{{N}_{i , j}}{{N}_{* j}} ) * log ( {DD}_{i} )$$

where N_{i,j} is the number of times word i appears in table j, N_{*,j} is the number of total words in the table j, D is the number of tables, and Dᵢ is the number of tables in which word i appears.

TFIDF is a numerical statistic that is intended to reflect how related a word is to a document in a collection or corpus. TFIDF may be used as a weighting factor in information retrieval and text mining. Typically, the TFIDF value increases proportionally to the number of times a word appears in a document, but is offset by the frequency of the word in the corpus, which helps control the fact that some words are generally more common than others. For example, if a query includes “the brown cow,” the word “the” is much more common than “brown” and “cow.” Summing a number of times a term appears, in on embodiment, provides a term frequency (“TF”). Simply summing the number of times “the” occurs may incorrectly emphasize “the” without giving enough weight to “brown” and “cow.” The term “the” is not a good keyword to distinguish relevant and non-relevant documents and terms, while less common “brown” and “cow” are more relevant to the query. An inverse document frequency (“IDF”) factor is incorporated into the TFIDF analysis to diminish the weight of terms that occur very frequently in a corpus and increases the weight of terms that occur less frequently.

In one embodiment, the apparatus 400 includes a storing module 406 that stores the new database entry in the concept table in response to determining that the degree of relatedness is above a relatedness threshold. In one embodiment, the storing module 406 stores data of the database entry in the concept table. In another embodiment, the storing module 406 stores a link to the database entry in the database. Typically, the database entry is stored in the concept table in such that related entries are stored together, thus providing an efficient way to access the related data that is more efficient than prior art caching techniques.

In one embodiment, the DOR module 404 determines a degree of relatedness between the concept of the data of the new database entry and each concept of several concept tables and may determine a degree of relatedness between the concept of the data of the new database entry and the concept of each concept table in cache 206. The storing module 406 may store the data of the new database entry in one or more concept tables. For example, the storing module 406 may store the data of the new database entry in each concept table where the degree of relatedness is above the relatedness threshold. In another embodiment, the storing module 406 may store the data of the new database entry in a concept table where the degree of relatedness is the highest. One of skill in the art will recognize other ways for the storing module 406 to determine which concept tables to store the data of the new database entry.

In one embodiment, the apparatus 400 includes a concept table module 408 that creates a new table in cache 206 in response to the degree of relatedness between the concept of the data of the new database entry and the concept of each concept table being below the relatedness threshold. The concept table created by the concept table module 408 includes the concept of the data of the new database entry. For example, the storing module 406 may store the new database entry in the new concept table. Once the concept table module 408 has created concept tables in cache 206 and the storing module 406 has stored entries in the concept tables, the DOR read module 302, the data usage module 304, the flushing rating module 306, and flushing module 308 may act to manage flushing to provide available space in cache 206 for storing additional entries.

In one embodiment, the apparatus 400 includes a cache reconfiguration module 410 that flushes the concept tables and entries associated with the concept tables from cache 206 in response to reconfiguring the database. From time to time reconfiguring the database may be desirable. For example, when the database is out of date, becomes inefficient, etc. Regeneration of the database may be triggered by many different factors, such as a number of requests to the database reaching a request limit, a percentage of data change within the database reaching a change limit, an operation time of the database reaching an operation time limit, an amount of new data added to the database reaching a new data limit, etc.

The apparatus 400, in one embodiment, includes a regeneration module 412 that, in response to the cache reconfiguration module 410 flushing the concept tables and entries in the concept tables from cache 206, processes entries in the database to extract one or more concepts and to create concept tables for the one or more concepts. The regeneration module 412 may add entries to the concept tables that have a degree of relatedness to a concept of the concept table above a relatedness threshold. The one or more concepts are stored in one or more concept tables in cache 206 along with data and associated entries from the database that relate to the one or more concepts. Each database entry stored in a concept table has a degree of relatedness above a relatedness threshold. In one embodiment, the degree of relatedness is stored with the database entry in the concept table. The cache reconfiguration module 410 and regeneration module 412, in one embodiment, work together after a triggering event to reconfigure cache 206 so that the cache 206 may be more efficient.

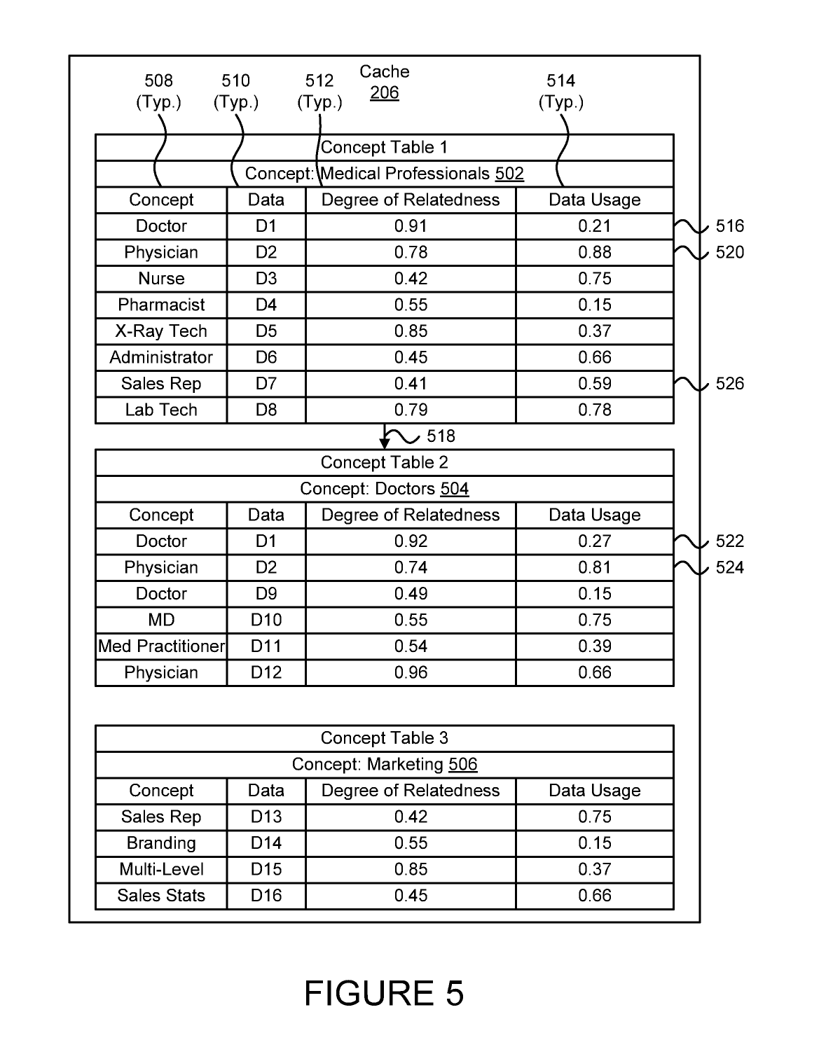

FIG. 5 is a diagram of one embodiment of cache 206 with concept tables in accordance with one embodiment of the present invention. The cache 206 includes three concept tables, concept table 1, concept table 2 and concept table 3, but one of skill in the art will recognize that cache 206 may include many other concept tables where some of the tables are related in a hierarchy. Each concept table, as depicted, includes a “concept” 502, 504, 506 for the table at the top, a “concept” column 508, a “data” column 510, a “degree of relatedness” column 512, and a “data usage” column 514. The concept tables are illustrative and one of skill in the art will recognize that a concept table stored in cache 206 will differ in structure and content.

The concepts 502, 504, 506 for each table listed at the top of each concept table are the concepts to which each database entry in the concept table is related. For example, concept table 1 includes a concept 502 of “medical professionals.” A degree of relatedness for a database entry is between the concept 502 “medical professionals” and the concept of the database entry. For example, the first database entry 516 of concept table 1 is the first line and includes a concept of “doctor,” data “D1,” a degree of relatedness of 0.91 and a data usage of 0.21. Prior to the storing module 406 storing the first database entry 516, in one embodiment the concept module 402 determined that at least one concept for data D1 of a new database entry was “doctor.”

The DOR module 404 may then have determined that the degree of relatedness between the concept 502 for concept table 1 of “medical professional” and the concept of the database entry, which is “doctor,” was 0.91. If a relatedness threshold for concept table 1, or for all of the concept tables, was 0.4, the storing module 406 may have placed the database entry in concept table 1 as the first database entry 516 with the concept of “doctor” in the concept column 508, data D1 of the database entry in the data column 510, the degree of relatedness of 0.91 in the degree of relatedness column 512 and an entry for data usage in the data usage column 514. The data usage for the database entry 516 is listed as 0.21 but typically changes over time as the database entry 516 is accessed or not. A low data usage, such as 0.21, may indicate that the database entry 516 is not being used very often.

In one embodiment, the degree of relatedness is based on the concept of a database entry and how closely the concept relates to the concept (e.g. “medical professional” to “doctor”). In another embodiment, the concept module 402 may determine a concept for a database entry but the degree of relatedness may include a measure of how strongly the concept is related to the data of the database entry. For example, for the first database entry 516 in concept table 1, the degree of relatedness may depend on the relationship between “doctor” and “medical professional” as well as how related “doctor” is to data D1. For instance, data D1 may mention “doctor” several times and have a strong correlation to “doctor” where another database entry may have a weak correlation between the concept of the database entry and the data of the database entry, resulting in a lower degree of relatedness.

Concept table 2 has a concept 504 of “doctors” and has a hierarchical relationship with concept table 1, as indicated by the arrow 518 between concept table 1 and concept table 2. The arrow 518, in the depicted embodiment, points toward concept table 2 because “doctors” may be considered a sub-concept of “medical professionals.” Other concept tables may have a more detailed hierarchy that may be multiple level, bi-directional, or related in other ways. In one embodiment, a database entry may be included in more than one concept table. For example, the first database entry 516 and the second database entry 520 of concept table 1 may also be included in concept table 2, and are shown as the first database entry 522 and second database entry 524 of concept table 2. In another embodiment, duplicate entries may be included in other concept tables using a link. One of skill in the art will recognize other ways to include a database entry in multiple concept tables.

The DOR read module 302 may read the degree of relatedness from one or more concept tables for one or more entries in the concept tables, for example, from the degree or relatedness column 512. The data usage module 304 may extract a data usage for a database entry from the data usage column 514 and the flushing rating module 306 may determine a cache flushing rating for the database entry. For example the flushing rating module 306 may multiply the degree of relatedness (e.g. 0.91 for the first database entry 516 of concept table 1) and the associated data usage (e.g. 0.21 for the first database entry 516 of concept table 1), which may result in a cache flushing rating of 0.1911. If a cache flush threshold is 0.2, the flushing module 308 may flush the database entry 516 from concept table 1. The data usage for the database entry 516 may start out high (e.g. 0.9) and may decrease over time so that the combination of the degree of relatedness 0.91 of the database entry 516 and a current data usage may be above or below a current cache flush threshold.

A database entry with a lower degree of relatedness, for example, the seventh database entry 526 in concept table 1, may be flushed sooner than a database entry with a higher degree or relatedness. For this database entry 526, the concept of “sales rep” may have a degree of relatedness of 0.41 so that for a cache flush threshold of 0.2, a data usage less than 0.2/0.41=0.4878 may result in the flushing module 308 flushing the database entry 526 from cache 206 while the first database entry 516 in concept table 1 may have a lower data usage before the database entry 516 is flushed by the flushing module 308 (e.g. 0.2/0.92=0.2198).

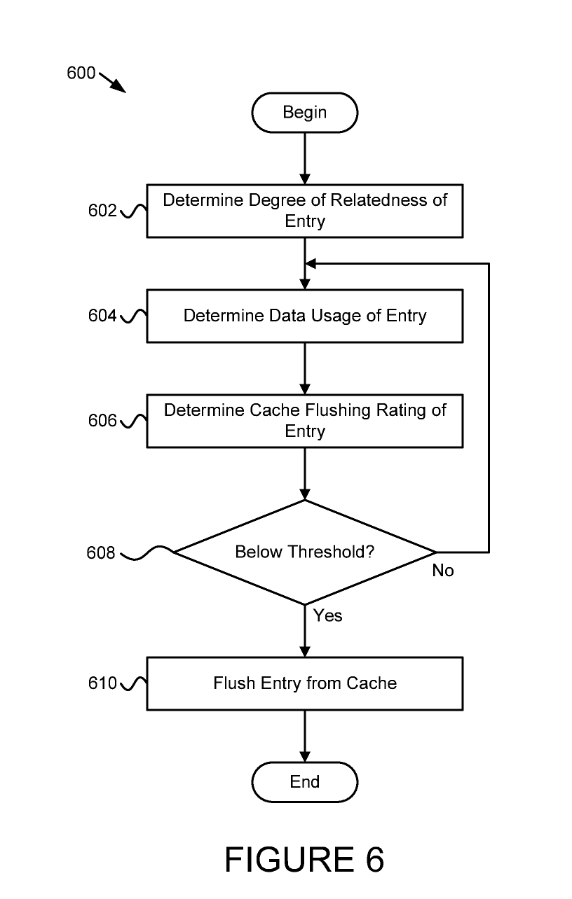

FIG. 6 is a schematic flow chart diagram illustrating one embodiment of a method 600 for flushing cache in accordance with one embodiment of the present invention. The method 600 begins and determines 602 a degree of relatedness for a database entry stored in a concept table in cache 206. For example, the method 600 may determine 602 the degree of relatedness by reading a previously calculated degree of relatedness stored with the database entry. In another embodiment, the method 600 may determine 602 the degree or relatedness by re-calculating a degree of relatedness between the concept of the concept table and the concept of the data of the database entry. Concept tables are stored in cache 206. The database entry is from a database and the degree of relatedness is between a concept of data of the database entry and a concept of the concept table. In various embodiments, the DOR read module 302 and/or the DOR module 404 may determine 602 the degree of relatedness.

The method 600 determines 604 data usage of the database entry and determines 606 a cache flushing rating of the database entry. The data usage may include an amount of usage of the database entry while in cache 206 and the cache flushing rating for the database entry is determined using the degree of relatedness and the data usage of the database entry. In some embodiments, the data usage module 304 determines the data usage of the database entry and the flushing rating module 306 determines the cache flushing rating for the database entry. The method 600 determines 608 if the cache flushing rating is below a cache flush threshold. If the method 600 determines 608 that the cache flushing rating is not below a cache flush threshold, the method 600 returns and determines 604 the data usage for the database entry. If the method 600 determines 608 that the cache flushing rating is below a cache flush threshold, the method 600 flushes 610 the database entry from cache 206, and the method 600 ends. In one embodiment, the flushing module 308 flushes the database entry from cache 206. While the method 600 of FIG. 6 describes actions related to one database entry, one of skill in the art will recognize that the method 600 may apply to multiple entries in multiple concept tables.

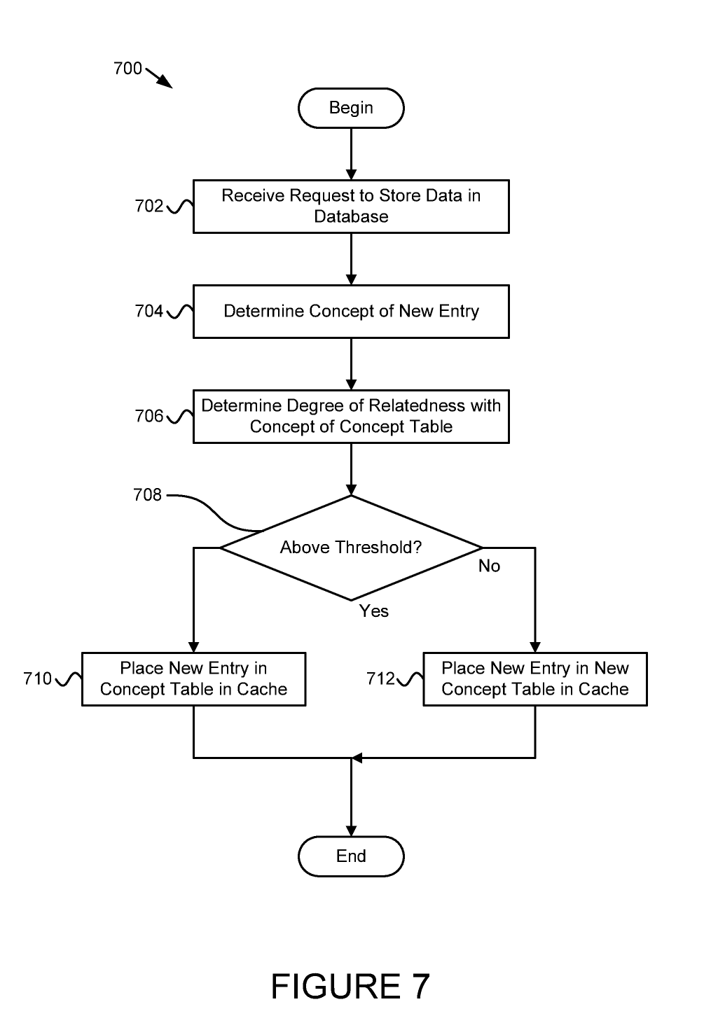

FIG. 7 is a schematic flow chart diagram illustrating one embodiment of a method 700 for organizing cache in accordance with one embodiment of the present invention. The method 700 begins and receives 702 a request to store a new database entry in the database and determines 704 a concept related to the data of the new database entry. In another embodiment (not shown) the method 700 determines 704 a concept in response to a request of another type, such as reading data from the database or comparing a database entry. In one embodiment, the concept module 402 determines 704 the concept of the data of the new database entry.

The method 700 determines 706 the degree of relatedness between the concept of the data of the new database entry and the concept of a concept table stored in cache 206. For example, the DOR module 404 may determine 706 the degree of relatedness. The method 700 determines 708 if the degree of relatedness for the new database entry is above a relatedness threshold. If the method 700 determines 708 that the degree of relatedness for the new database entry is above the relatedness threshold, the method 700 stores 710 the new database entry in the concept table, and the method 700 ends. If the method 700 determines 708 that the degree of relatedness for the new database entry is not above the relatedness threshold, the method 700 places 712 the new database entry in a new concept table in cache 206, and the method 700 ends.

In various embodiments, the method 700 may determine 706 a degree of relatedness between the data of the new database entry and the concept of some or all of the concept tables in cache 206 and may, for each concept table where a degree of relatedness was determined 706, determine 708 if the degree of relatedness is above the relatedness threshold and then may store the new database entry in the applicable concept table. If the method 700 determines 708 that the degree of relatedness for the new database entry is not above the relatedness threshold for any concept table in cache 206, the method 700 places 712 the new database entry in a new concept table in cache 206, and the method 700 ends. In one embodiment, the method 600 of FIG. 6 and the method 700 of FIG. 7 run concurrently. For example, upon receipt of a request to store data in the database, the method 600 of FIG. 6 may be used to free up space in the cache 206 and the method 700 of FIG. 7 may then determine where one or more new entries may be stored. One of skill in the art will recognize other ways that the methods 600, 700 of FIGS. 6 and 7 may work together to manage cache (e.g. the cache 206 of server 104).

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
determining a degree of relatedness for a database entry stored in a concept table, the concept table being stored in cache, wherein the degree of relatedness is based on a comparison between a concept of data of the database entry and a concept of the concept table;
determining an amount of data usage for the database entry, the data usage comprising an amount of usage of the database entry while in cache;
determining a cache flushing rating for the database entry, the cache flushing rating determined from the degree of relatedness of the database entry and the amount of data usage of the database entry; and
flushing the database entry from the cache in response to the cache flushing rating of the database entry being below a cache flush threshold.

2. The method of claim 1, further comprising:
determining a concept related to data for a new database entry;
determining a degree of relatedness between the concept of the data of the new database entry and the concept of a concept table stored in cache; and
storing the new database entry in the concept table in response to determining that the degree of relatedness is above a relatedness threshold.

3. The method of claim 2, further comprising using latent semantic analysis with respect to the concept of the data of the database entry and the concept of the concept table, wherein the latent semantic analysis at least results in determining the degree of relatedness between the concept of the data of the database entry and the concept of the concept table.

4. The method of claim 3, wherein the latent semantic analysis further comprises using singular value decomposition (“SVD”).

5. The method of claim 4, wherein the latent semantic analysis further comprises using term frequency-inverse document frequency and a resulting matrix is processed using singular value decomposition.

6. The method of claim 2, wherein the degree of relatedness is stored in the concept table with the database entry and the concept of the data of the database entry comprises a first topic that relates to the database entry and the concept of the concept table comprises a second topic that relates to entries in the concept table in cache.

7. The method of claim 2, wherein the cache comprises two or more concept tables, each concept table is related to a different concept and further comprising creating a new table in cache in response to the degree of relatedness between the concept of the data of the new database entry and the concept of each concept table being below the relatedness threshold, wherein the created concept table comprises the concept of the data of the new database entry.

8. The method of claim 1, wherein the cache flush threshold is dynamic and changes based on one or more of cache resources and cache requirements of data written to cache.

9. The method of claim 1, wherein the data usage is determined from one or more of:
frequency of use of data of the database entry;
cache accesses to the database entry;
cache hits of the database entry; and
cache misses.

10. The method of claim 1, further comprising flushing a plurality of entries from the cache, wherein each flushed database entry has a cache flushing rating below the cache flush threshold.

11. The method of claim 1, further comprising flushing concept tables and associated entries in the concept tables from cache in response to reconfiguring the database.

12. The method of claim 11, wherein reconfiguring the database is triggered by one or more of:
a number of requests to the database reaching a request limit;
a percentage of data change within the database reaching a change limit;
an operation time of the database reaching an operation time limit; and
an amount of new data added to the database reaching a new data limit.

13. The method of claim 11, further comprising, in response to flushing the concept tables and entries in the concept tables from cache, processing entries in the database to extract one or more concepts, the one or more concepts stored in one or more concept tables in cache along with data and associated entries from the database that relate to the one or more concepts, wherein each database entry stored in a concept table has a degree of relatedness above a relatedness threshold, the degree of relatedness stored with the database entry in the concept table.

14. The method of claim 1, wherein the cache comprises two or more cache levels and wherein each cache level comprises a cache flush threshold, wherein flushing the database entry from the cache in response to the cache flushing rating of the database entry being below a cache flush threshold comprises flushing the database entry from a cache level in response to the cache flushing rating of the database entry being below a cache flush threshold for the cache level.
